(19) United States
(12) Patent Application Publication
(10) Pub. No.: US 2017/0109107 A1
(43) Pub. Date: Apr. 20, 2017

(54) IMAGE FORMING APPARATUS CAPABLE OF CANCELING JOB AT WHICH ERROR OCCURS, METHOD OF CONTROLLING THE IMAGE FORMING APPARATUS, AND STORAGE MEDIUM

(71) Applicant: CANON KABUSHIKI KAISHA, Tokyo (JP)

(72) Inventor: Takashi Kuroda, Tokyo (JP)

(21) Appl. No.: 15/291,458

(22) Filed: Oct. 12, 2016

(30) Foreign Application Priority Data
Oct. 14, 2015 (JP) 2015-202784

(51) Int. Cl. G06F 3/12

(52) U.S. Cl. CPC G06F 3/1234; G06F 3/121; G06F 3/1204; G06F 3/1286

(57) ABSTRACT

An image forming apparatus capable of canceling a job after the lapse of a time period appropriately set on an error factor basis. A CPU detects occurrence of an error in printing and a factor of the error. A job control processing module suspends a job at which occurrence of an error is detected. A printing processing module sets a grace period according to an error factor of the detected error. When the grace period elapses after the job is suspended, the job control processing module cancels the suspended job.

### BACKGROUND OF THE INVENTION

Field of the Invention

The present invention relates to a technique which makes it possible to cancel a job at which an error occurs.

Description of the Related Art

Conventionally, in an office environment, a plurality of users input print jobs to an image forming apparatus from their host computers, respectively, using e.g. printer drivers of the respective host computers and carry out work for causing the image forming apparatus to perform printing. As a measure taken in a case where the image forming apparatus has stopped due to occurrence of an error, such as a jam, there has been proposed a method in which a user manually recovers from the error without powering off the apparatus, and then resumes a print job. Further, Japanese Patent Publication No. 4584731 has proposed a method in which the image forming apparatus automatically cancels a print job at which an error occurs.

In the above-described technique, however, when a job is canceled immediately after occurrence of an error, efficiency in printing processing is reduced, which increases workload on a user. On the other hand, in the case of resuming a suspended job, in an environment where a plurality of print jobs have been input, if work for recovery from the error is carried out by another person than the user, this sometimes allows, only after the lapse of a long time period, the job to be resumed to output printed matter. In such a case, there is a fear of occurrence of a security problem that confidential printed matter might be accidentally viewed by a third person.

To solve the problem of the conventional technique, there has been proposed a technique which enables a user to set a time period from occurrence of an error to cancellation of a print job, as desired, and makes it possible to automatically cancel the print job upon expiration of the set time period.

Incidentally, there are a plurality of error factors causing an image forming apparatus to stop a print job, and the time period required for work of recovery from the error can differ depending e.g. on an error factor or an installation environment specific to the image forming apparatus. For example, in order to recover from an error due to paper-out, it is required to replenish a sheet feed cassette with sheets, and if the sheets for replenishment are stored at a location distant from the image forming apparatus, a time period from occurrence of the error to recovery from the same inevitably becomes long. For this reason, assuming that a print job is canceled upon expiration of a uniform time period set irrespective of an error factor, the job can be canceled against a user's intention before the user completes the work of recovery from the error. In this case, the user has to input the job again, which is troublesome.

### SUMMARY OF THE INVENTION

The present invention provides an image forming apparatus capable of canceling a job after the lapse of a time period appropriately set on an error factor basis, a method of controlling the image forming apparatus, and a storage medium.

In a first aspect of the invention, there is provided an image forming apparatus comprising a setting unit configured to set a grace period on an error factor basis, a detection unit configured to detect occurrence of an error in printing and a factor of the error, a suspension unit configured to suspend a job at which occurrence of an error is detected by the detection unit, and a cancellation unit configured to cancel the suspended job, based on that a grace period set according to the error factor detected by the detection unit elapses after the job is suspended by the suspension unit.

In a second aspect of the invention, there is provided a method of controlling an image forming apparatus, comprising setting a grace period on an error factor basis, detecting occurrence of an error in printing and a factor of the error, suspending a job at which occurrence of an error is detected by the detecting, and canceling the suspended job, based on that a grace period set by the setting according to the detected error factor by the detecting elapses after the job is suspended by the suspending.

In a third aspect of the invention, there is provided a non-transitory computer-readable storage medium storing a computer-executable program for executing a method of controlling an image forming apparatus, wherein the method comprises setting a grace period on an error factor basis, detecting occurrence of an error in printing and a factor of the error, suspending a job at which occurrence of an error is detected by the detecting, and canceling the suspended job, based on that a grace period set by the setting according to the detected error factor by the detecting elapses after the job is suspended by the suspending.

According to the invention, it is possible to cancel a job after the lapse of a time period appropriately set on an error factor basis.

Further features of the present invention will become apparent from the following description of exemplary embodiments (with reference to the attached drawings).

### BRIEF DESCRIPTION OF THE DRAWINGS

FIG. 1 is a block diagram of an image forming apparatus according to an embodiment of the present invention.

FIG. 2 is a diagram showing the software module configuration of the image forming apparatus.

FIG. 3 is a flowchart of a job process.

FIG. 4 is a view of an example of an automatic cancellation configuration screen for setting automatic cancellation of a suspended job.

FIG. 5 is a view of an example of a job list.

FIG. 6 is part of a flowchart of a variation of the job process.

### DESCRIPTION OF THE EMBODIMENTS

The present invention will now be described in detail below with reference to the accompanying drawings showing embodiments thereof.

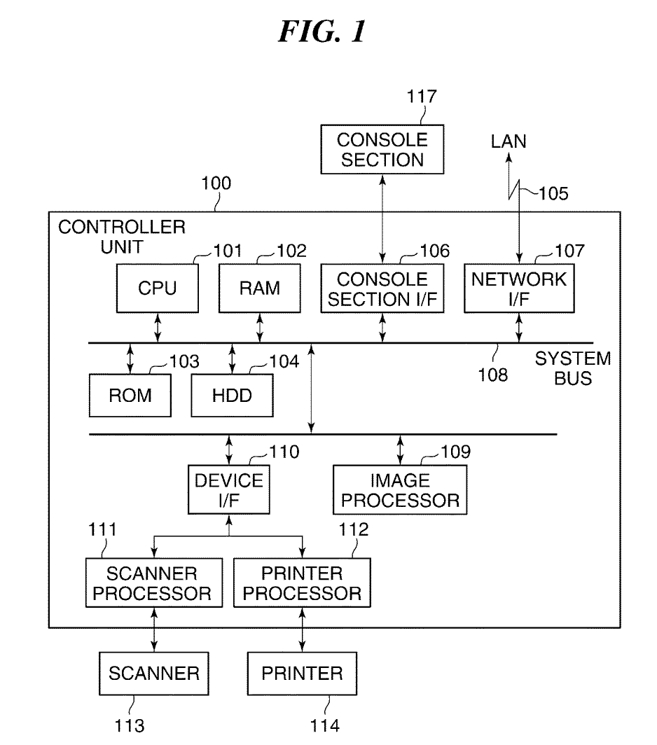

FIG. 1 is a block diagram of an image forming apparatus according to an embodiment of the invention. The image forming apparatus is comprised of a controller unit 100 for controlling the entire apparatus, a scanner 113 as an image input device, a printer 114 as an image output device, and a console section 117 for inputting instructions from an operator and displaying information to the operator. Each of the scanner 113, the printer 114, and the console section 117 is connected to the controller unit 100 and is controlled according to instructions from the controller unit 100. The scanner 113 is connected to a scanner processor 111 of the controller unit 100, and the printer 114 is connected to a printer processor 112 of the controller unit 100.

The controller unit 100 includes a CPU 101. The CPU 101 is connected to a RAM 102, a ROM 103, an HDD 104, a console section interface 106, and a network interface 107, via a system bus 108. The RAM 102 is a memory for providing a work area for the CPU 101. The RAM 102 is used as a settings storage memory for temporarily storing parameter settings, and an image memory for storing part of image data. The ROM 103 is a boot ROM and stores a system boot program. The HDD 104 stores system software, history of the parameter settings, image data, and so forth. The CPU 101 is placed in a state capable of executing controller programs by loading the system boot program stored in the ROM 103 into the RAM 102.

The console section interface 106 is an interface for input to and output from the console section 117. The console section interface 106 outputs image data to be displayed to the console section 117 according to instructions from the CPU 101, and transfers information input by the operator via the console section 117 to the CPU 101. The network interface 107 is connected to a LAN 105, and performs delivering and receiving information to and from the LAN 105. An image processor 109 rasterizes a PDL (page description language) code received from the LAN 105 into a bitmap image. Before the printer processor 112 processes image data to output the resulting image data to the printer 114, the image processor 109 processes the image data, which is stored in the HDD 104 in a compressed and encoded state, into a format usable by the printer processor 112. A device interface 110 is connected to the scanner 113 and the printer 114 via the scanner processor 111 and the printer processor 114, respectively, and performs synchronous-to-asynchronous or asynchronous-to-synchronous conversion of image data, and transfer of data of settings, adjustment values, and a device status.

The scanner processor 111 performs various kinds of processing, including correction, manipulation, image area separation, scaling, binarization, and other editing processing, on image data input from the scanner 113. The scanner 113 includes an automatic document feeder and an image reading device including a platen glass, neither of which is shown, and is capable of reading both sides of each of a plurality of originals. Further, the scanner 113 includes sensors for detecting the opening/closing of a document cover, not shown, the presence of an original, and the size of the original. The detected information and the status information of the scanner 113 are sent to the CPU 101 via the scanner processor 111 and the device interface 110. The printer processor 112 performs processing on image data to be printed out, such as correction and resolution conversion dependent on the printer 114, and adjustment of print position of an image. The printer 114 has one or more sheet feed cassettes, not shown, for storing sheets for printing. Information indicative of the remaining amount of sheets in each sheet feed cassette, the presence/absence of toner, and so forth is sent to the CPU 101 via the printer processor 112 and the device interface 110.

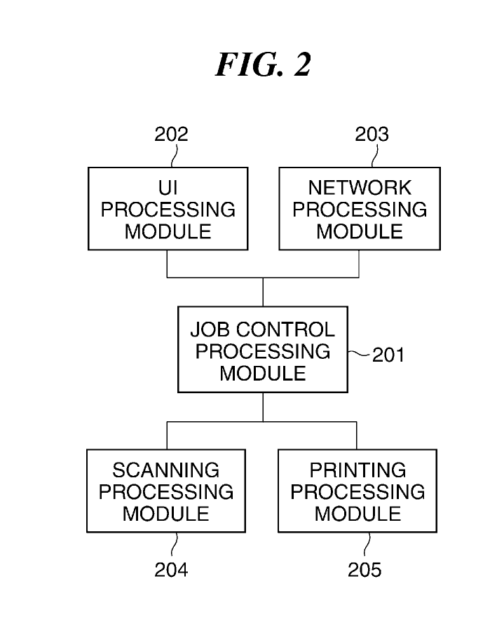

FIG. 2 is a diagram showing the software module configuration of the image forming apparatus. Software modules shown in FIG. 2 mainly operate on the CPU 101. More specifically, a program stored in the HDD 104 is loaded into the RAM 102 and is executed by the CPU 101, whereby the modules are realized. A job control processing module 201 controls the software modules shown in FIG. 2 (and software modules, not shown), and controls every job generated in the image forming apparatus, such as a copy job, a print job, a scan job, and a user interface processing job. A user interface (UI) processing module 202 performs control associated mainly with the console section 117 and the console section interface 106. The user interface processing module 202 notifies the job control processing module 201 of an operation of the console section 117 performed by a user. Further, the user interface processing module 202 controls contents to be displayed on a display screen of the console section 117, based on instructions from the job control processing module 201, controls editing of image data to be displayed on the console section 117, and so forth.

A network processing module 203 controls communication with the outside of the image forming apparatus, such as communication with apparatuses on the LAN 105, which is performed mainly via the network interface 107. When the network processing module 203 receives a control command or data from any of the apparatuses on the LAN 105, the network processing module 203 notifies the job control processing module 201 of the received contents. Further, the network processing module 203 transmits a control command or data to any of the apparatuses on the LAN 105 based on instructions from the job control processing module 201. A scanning processing module 204 controls the scanner 113 and the scanner processor 111, based on instructions from the job control processing module 201, to read an original set on the scanner 113. Then, the scanning processing module 204 instructs the scanner processor 111 to perform image processing on the read original image. Further, the scanning processing module 204 acquires status information of the scanner processor 111 and the scanner 113, and notifies the job control processing module 201 of the acquired information.

A printing processing module 205 controls the image processor 109, the printer processor 112, and the printer 114, based on instructions from the job control processing module 201, to perform printing processing on a designated image. The printing processing module 205 receives image data, image information (the size, color mode, resolution, etc. of image data), layout information (offset, magnification/reduction, imposition, and so forth), output sheet information (the size and printing direction), and so forth, from the job control processing module 201. Then, the printing processing module 205 controls the image processor 109 and the printer processor 112 to perform proper image processing on the image data, and controls the printer processor 112 and the printer 114 to print the processed image data on a printing sheet. Further, the printing processing module 205 acquires status information of the printer processor 112 and the printer 114, and notifies the job control processing module 201 of the acquired information.

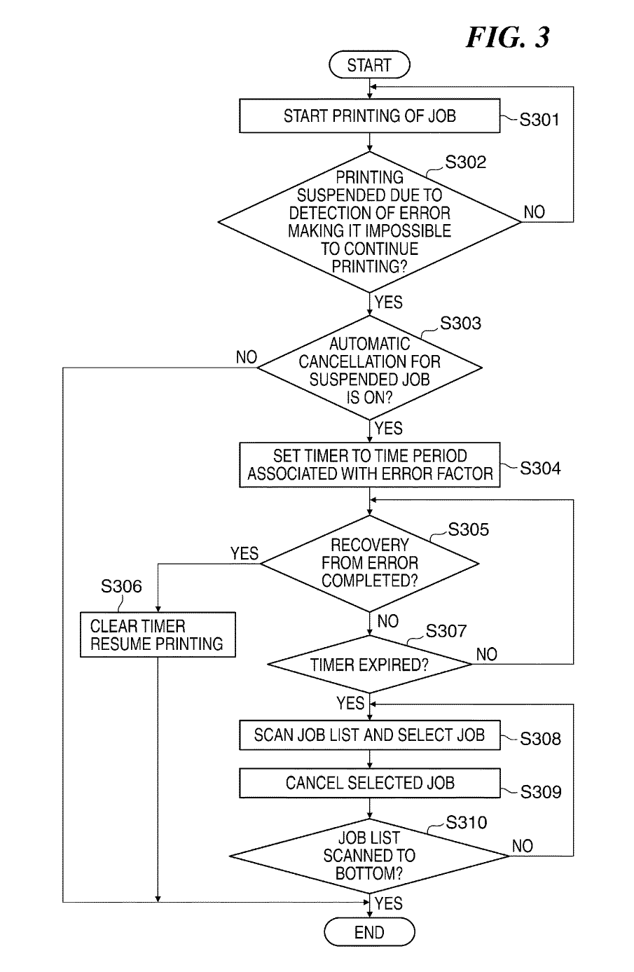

FIG. 3 is a flowchart of a job process. The job process is realized by the CPU 101 by loading a program stored in the HDD 104 into the RAM 102 and executing the same. The present process is started when a job is input.

The CPU 101 receives an instruction for executing a job from a user via the user interface section 202, and accepts the job, by requesting the printing processing module 205 to execute the job according to the job execution instruction, via the control processing section 201. Alternatively, the CPU 101 receives, via the network processing module 203, print information for a job sent from an external computer, not shown, via the LAN 105 and the network interface 107. Then, the CPU 101 accepts the job by requesting the printing processing module 205 to execute the job via the job control processing module 201 based on the information received via the network processing module 203. When the job is accepted, the CPU 101 starts printing processing of the job (step S301). Incidentally, accepted jobs are registered in a job list (see FIG. 5) stored in the RAM 102, in the order of acceptance, start to be subjected to printing processing in the order of registration, and are deleted from the job list after completion of printing.

Then, in a step S302, the CPU 101 detects an occurrence of such an error as will make it impossible to continue the printing processing of the job and a factor (type) of the error which has been detected, and determines whether or not the job under execution of the printing processing has been suspended. More specifically, first, the CPU 101 receives a notification of error information from the printer 114 via the printer processor 112 and the device interface 110. Here, the CPU 101 corresponds to a detection unit of the invention.

Error information notified from the printer 114 contains an error factor, such as paper-out detected when sheets in a sheet feed cassette, not shown, run out, toner-out detected when toner runs out, or jam occurrence detected when a jam occurs. Jam occurrence is notified according to a signal from one of conveyance sensors, not shown, disposed along a sheet conveying path. When the CPU 101 is notified of the error information, the CPU 101 notifies the printing processing module 205 of the error information. In response to the notification, the printing processing module 205 sends the error information to the job control processing module 201. In response to this, the job control processing module 201 requests the printing processing module 205 to stop the job. This causes the job to be suspended. The job control processing module 201 notifies the user interface processing module 202 of the error information received from the printing processing module 205. In response to this, the user interface processing module 202 causes the console section 117 to display an error screen associated with the error information. The job control processing module 201 serves as a suspension unit of the invention.

In the step S302, if no occurrence of such an error as will make it impossible to continue the printing processing of the job is detected, the process returns to the step S301, whereas if it is determined that the job under execution of the printing processing has been suspended, the process proceeds to a step S303. In the step S303, the printing processing module 205 determines whether or not a setting of automatic cancellation of a suspended job is ON.

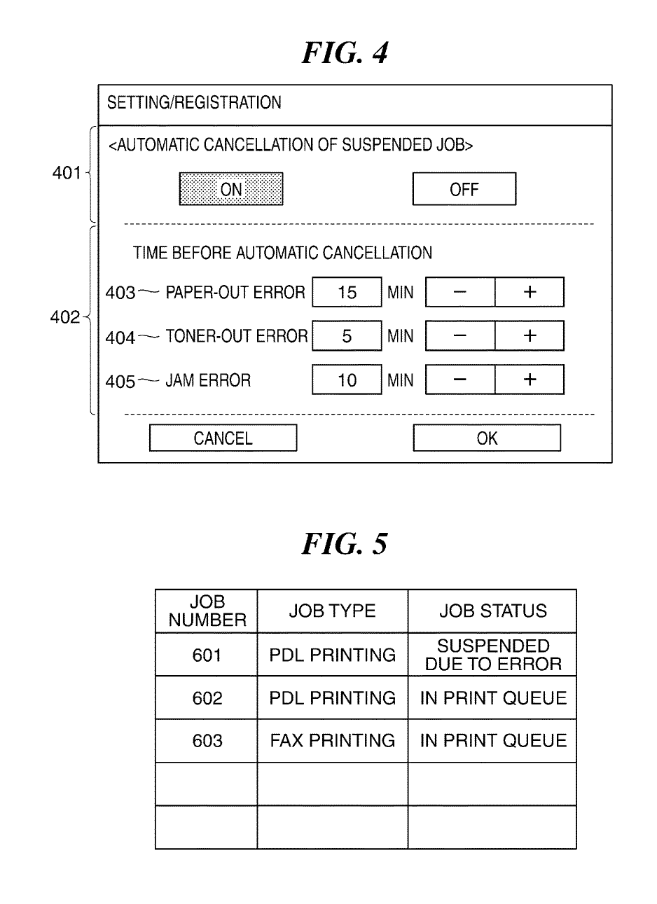

FIG. 4 is a view of an example of an automatic cancellation configuration screen for setting automatic cancellation of a suspended job. This configuration screen is displayed on the console section 117 at any time according to an instruction from the user, and is controlled by the user interface processing module 202 according to an instruction from the job control processing module 201. In an ON/OFF setting field 401, it is possible to set whether or not to execute (ON/OFF of) automatic cancellation of a suspended job. In a time setting area 402, it is possible to set a grace period from a time point when a job is stopped to a time point when automatic cancellation is executed. In the time setting area 402, a grace period can be set on an error factor basis. Specifically, setting fields 403, 404, and 405 are provided for the respective error factors, i.e. paper-out, toner-out, and jam occurrence, and it is possible to individually set a grace period in each of the setting fields 403, 404, and 405. Note that error factors are not limited to the above-mentioned examples.

When an OK button is pressed in the FIG. 4 configuration screen, the settings for automatic cancellation are finalized, and setting information on the settings for automatic cancellation is stored in the HDD 104 or a nonvolatile memory, not shown. In setting of the automatic cancellation, the job control processing module 201 serves as a setting unit of the invention.

If it is determined in the step S303 that the setting of automatic cancellation for the suspended job is OFF, it is not required to execute automatic cancellation, and therefore the printing processing module 205 terminates the FIG. 3 process. On the other hand, if the setting of automatic cancellation for the suspended job is ON, the printing processing module 205 sets a timer to a grace period set in the time setting area 402 (FIG. 4), and starts time measurement (step S304). More specifically, the printing processing module 205 acquires an error factor of the error having occurred this time from the error information sent from the printer 114 in the step S302. Then, the printing processing module 205 acquires one, which is associated with the acquired error factor, of the grace periods set in the respective setting fields 403, 404, and 405, as a grace period associated with the error factor, and sets the timer to the grace period and start time measurement.

Then, in a step S305, the CPU 101 determines whether or not recovery from the error having occurred has been completed. More specifically, first, the CPU 101 accepts an error recovery request from the printer 114 via the printer processor 112 and the device interface 110. The CPU 101 notifies the error recovery request to the printing processing module 205. Then, according to the notification from the CPU 101, the printing processing module 205 executes error recovery processing. When the CPU 101 receives an error recovery notification from the printing processing module 205, it is determined in the step S305 that that error from the error has been completed. If it is determined in the step S305 that recovery from the error has not been completed, the printing processing module 205 determines whether or not the timer has expired (step S307). If the timer has not expired, the process returns to the step S305 so as to await recovery from the error while maintaining the suspended state of the job. When recovery from the error is completed before the timer expires, the process proceeds to a step S306. When the timer expires without recovery from the error, the process proceeds to a step S308.

In the step S306, the printing processing module 205 clears the timer and notifies the job control processing module 201 of the error recovery. The job control processing module 201 notified of the error recovery transfers the notification to the user interface processing module 202. In response to this, the user interface processing module 202 stops displaying the error screen thus far displayed on the console section 117. Further, the job control processing module 201 instructs the printing processing module 205 to resume printing of the suspended job, followed by terminating the present process.

In the step S308, the printing processing module 205 notifies the job control processing module 201 that the grace period has elapsed, and the job control processing module 201 having received the notification scans a list of jobs ever received, from its top, and selects a job. In the present example, jobs are selected in the order of acceptance. Then, the job control processing module 201 cancels the selected job (step S309), and the process proceeds to a step S310. The job control processing module 201 serves as a cancellation unit of the invention.

In the step S310, the job control processing module 201 determines whether or not the job list has been scanned to its bottom. If the job list has not been scanned to its bottom, the job control processing module 201 returns to the step S308, and selects a next job to execute the step S309 et seq. On the other hand, if the job list has been scanned to its bottom, the FIG. 3 process is terminated. Thus, each of subsequent jobs accepted after the suspended job is automatically canceled.

FIG. 5 is a view of an example of the job list stored in the RAM 102. In this job list, there are registered uncompleted jobs in the order of input, and a job number, a job type, and a job status are recorded in association with each job. When the job status changes to a completed state, the registered job is deleted from the job. In the FIG. 5 example, a top job assigned a job number 601 is in a state suspended due to error, and each of the subsequent jobs assigned respective job numbers 602 and 603 is in print queue, i.e. in a state waiting for its turn for printing.

According to the present embodiment, when an error occurs during printing of a job, the job is suspended, and when a grace period set according to the factor of the error elapses after the suspension of the job, the suspended job is automatically canceled. Each of subsequent jobs accepted after the suspended job is also canceled. A grace period can be set on an error factor basis, so that it is possible to cancel each job after the lapse of an appropriate time period associated with its error factor.

For example, when the factor of an error is paper-out, it sometimes takes longer to recover from the error than to recover from errors due to the other factors. To cope with this problem, it can be envisaged that a user sets a longer time period in the setting field 403 associated with paper-out than in the other setting fields.

Further, on condition that execution of cancellation of a job has been set, the job is canceled upon the lapse of a grace period set for the job, so that it is possible to improve user friendliness. Furthermore, after suspension of a job, when recovery from an error is completed before the lapse of a grace period set for the job, the suspended job is resumed. Thus, it is possible to promptly resume the suspended job upon recovery from the error.

In the embodiment described above, in a case where it takes a long time before the user completes error recovery, the job is canceled due to the lapse of the grace period. However, there is a case where the user does not desire cancellation of the job even though he/she knows that error recovery requires a long time. The following description is given of a variation of the job process described with reference to FIG. 3, which is configured, in view of the above-mentioned case, to allow the once set grace period to be set again.

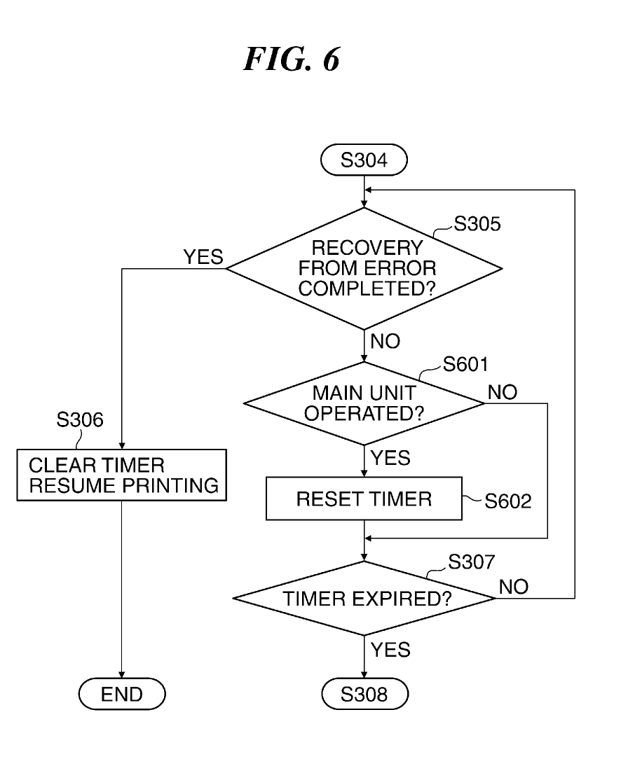

FIG. 6 is a flowchart of part of the variation of the job process. This flowchart is distinguished from the flowchart in FIG. 3 in that steps S601 and S602 are interposed between the steps S305 and S307. The steps S301 to S303, S309, and S310 are omitted from illustration in FIG. 6. The steps S301 to S304 and S306 to S310 are the same as those in the first embodiment (FIG. 3).

If it is determined in the step S305 that recovery from the error has not been completed, the process proceeds to the step S601. In the step S601, the CPU 101 determines whether or not a predetermined operation (main unit operation in this variation) has been performed. Examples of the main unit operation include an operation for opening the sheet feed cassette, not shown, and an operation for opening a cover of the main unit of the image forming apparatus. The CPU 101 determines that a main unit operation has been performed, by receiving from the printer 114 via the printer processor 112 and the device interface 110, a notification indicating that the sheet feed cassette or the body cover has been opened. Note that the predetermined operation is not limited to these, but it may be any other operation that is performed on the image forming apparatus by a user. If it is determined in the step S601 that no main unit operation has been performed, the process proceeds to the step S307, whereas if a main unit operation has been performed, the process proceeds to the step S602.

In the step S602, the CPU 101 sets a grace period in the timer again. Several methods can be envisaged to perform timer resetting for this. For example, the CPU 101 resets the timer to a grace period associated with the factor of an error that occurred this time, and starts time measurement. As an alternative, the CPU 101 may receive a time period input by the user, set the timer to the received time period, and then start time measurement. As a further alternative, the CPU 101 may set the timer to a fixed time period, and then start time measurement. As a method other than these, time measurement may be continued by adding time to the remaining time of the original grace period. In this case, as the time to be added, it is possible to set a time period which is as long as the original grace period, the above-mentioned time period received from the user, or the fixed time period. It is preferable that the timer is reset such that the time period before expiration of the timer is prolonged, i.e. the expiration time of the timer is later than that of the once set grace period, but this is not limitative.

After execution of the step S602, the process proceeds to the step S307. If it is determined in the step S307 that the timer has not expired, the process returns to the step S305 so as to await error recovery or timer resetting while maintaining the suspended state of the job. Therefore, in a case where the process returns to the step S305 after timer resetting, cancellation of the job is executed after expiration of the reset grace period. Note that the number of times of timer resetting in the step S602 is not required to be limited to one time, but the timer may be reset a plurality of times.

According to the present embodiment, a job is canceled after the lapse of a time period appropriately set on an error factor basis, and hence it is possible to obtain the same advantageous effect as provided by the first embodiment. Further, the time point of job cancellation can be changed by the predetermined operation performed before the lapse of a grace period, so that it is possible to improve user-friendliness e.g. in that the time period before job cancellation can be intentionally prolonged by the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)m), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-202784 filed Oct. 14, 2015 which is hereby incorporated by reference herein in its entirety.

What is claimed is:

1. An image forming apparatus comprising:
a setting unit configured to set a grace period on an error factor basis;
a detection unit configured to detect occurrence of an error in printing and a factor of the error;
a suspension unit configured to suspend a job at which occurrence of an error is detected by the detection unit; and
a cancellation unit configured to cancel the suspended job, based on that a grace period set according to the error factor detected by the detection unit elapses after the job is suspended by the suspension unit.

2. The image forming apparatus according to claim 1, wherein the setting unit sets whether or not to execute job cancellation, and
wherein on condition that execution of job cancellation has been set by the setting unit, the cancellation unit cancels the suspended job when the grace period elapses.

3. The image forming apparatus according to claim 1, wherein when the grace period elapses after the job is suspended by the suspension unit, the cancellation unit also cancels subsequent jobs accepted after the suspended job.

4. The image forming apparatus according to claim 1, wherein in a case where recovery from the error having occurred is detected by the detection unit before the grace period elapses after the job is suspended by the suspension unit, the suspended job is resumed.

5. The image forming apparatus according to claim 1, wherein when a predetermined operation is performed before the grace period elapses after the job is suspended by the suspension unit, the setting unit sets the grace period again, and
wherein when the grace period set by the setting unit again elapses after the job is suspended by the suspension unit, the cancellation unit cancels the suspended job.

6. The image forming apparatus according to claim 5, wherein the setting unit sets the grace period again such that an expiration time of the grace period set again becomes later than an expiration time of the grace period precedingly set.

7. The image forming apparatus according to claim 1, wherein the error factor includes at least one of paper-out, toner-out, and occurrence of a jam.

8. A method of controlling an image forming apparatus, comprising:
setting a grace period on an error factor basis;
detecting occurrence of an error in printing and a factor of the error;
suspending a job at which occurrence of an error is detected by the detecting; and
canceling the suspended job, based on that a grace period set by the setting according to the detected error factor by the detecting elapses after the job is suspended by the suspending.

9. A non-transitory computer-readable storage medium storing a computer-executable program for executing a method of controlling an image forming apparatus,
wherein the method comprises:
setting a grace period on an error factor basis;
detecting occurrence of an error in printing and a factor of the error;
suspending a job at which occurrence of an error is detected by the detecting; and
canceling the suspended job, based on that a grace period set by the setting according to the detected error factor by the detecting elapses after the job is suspended by the suspending.
